(19) United States
(12) Patent Application Publication
(10) Pub. No.: US 2003/0103633 A1
(43) Pub. Date: Jun. 5, 2003

(54) Kids ear saver headphone adapter

(76) Inventor: Thomas O. Metcalfe III, Madison, MS (US)

Correspondence Address: Clinton R. Stuart, P.O. Box 4412, Baton Rouge, LA, 70821-4412, US

(21) Appl. No.: 10/286,520

(22) Filed: Nov. 1, 2002

Related U.S. Application Data
(60) Provisional application No. 60/337,443, filed on Nov. 1, 2001.

(51) Int. Cl. H04B 3/00; H01R 33/945

(52) U.S. Cl. 381/77; 439/577

(57) ABSTRACT

The Kids Ear Saver Headphone Adapter (“KESHA”) is a device designed for use with headphones for stereo sound system equipment. The purpose of KESHA is to prevent permanent hearing loss associated with listening to music using headphones at excessive volumes, specifically with regard to children. Parents may use KESHA as a safeguard, in order to help reduce the chances that their children will suffer serious hearing damage due to the use of headphones. KESHA accomplishes this by permanently affixing a sound dampening circuit in place in the transmission line between the sound system equipment and the headphones. The sound dampening circuit acts upon the electronic sound signal from the sound system, effectively reducing the volume to a safer level prior to transmission to the headphones. And by permanently affixing the sound dampening circuit in place, children are unable to simply disengage or disable the protection provided by KESHA.

### BACKGROUND OF THE INVENTION

Headphones are often used when listening to stereo sound system equipment, so that the listener may use the stereo equipment without disturbing others. Children are often particularly fond of headphones, since headphones allow them to listen to their music without bothering their parents, providing a feeling of privacy and unrestrained freedom that teens seem to crave. Unfortunately, children tend to listen to music on their stereo headphones at volumes far above the recommended safety level, risking permanent hearing damage that can affect them for the rest of their lives. The present invention of the Kids Ear Saver Headphone Adapter (“KESHA”) is specifically designed to help parents guard against this problem.

Generally, the KESHA invention applies to the field of hearing protection. More specifically, KESHA is designed to assist in reducing the chances of sustaining hearing loss related to listening to music or other sound from electrical sound generating equipment, such as a stereo equipment, using headphones. Since prolonged exposure to high decibel levels is the primary cause for concern, KESHA focuses on reducing the chances for hearing loss by reducing the exposure to high end decibel levels transmitted through the headphones.

To accomplish its goals, KESHA utilizes two primary elements: a sound dampening circuit and a means for affixing the sound dampening circuit in place, so that it cannot be easily removed. The sound dampening circuit acts to reduce the sound exposure within the headphones, so that the listener will not be exposed to the high decibel levels which would cause permanent hearing loss. The means for affixing the sound dampening circuit in place acts to lock the sound dampening circuit in place, so that children will not circumvent the hearing protection that their parents have provided by removing the sound dampening circuit when their parents are not present. In this way, KESHA provides a simple but effective way for parents to protect their children's hearing from damage caused by improper use of headphones with excessive volume. Stated another way, KESHA provides an effective parental control mechanism for stereo headphones, which may assist parents in protecting their children from inadvertently doing permanent damage to their hearing.

### SUMMARY OF THE INVENTION

The Kids Ear Saver Headphone Adapter (“KESHA”) is a device which interfaces with a standard headphone unit, of the type widely available for use with standard sound system equipment and which typically plugs into a standard headphone jack in such sound system equipment, in order to act upon the electronic sound signal transmitted from the sound system equipment to the headphones so that the high end decibel level is reduced to a level which is less likely to cause any permanent hearing loss in children using the headphones. The sound reduction to the high end decibel level of the electronic signal transmitted from the sound system equipment to the headphones is accomplished using sound dampening circuitry. And since KESHA is intended primarily for use with children, it also includes a means for locking the sound dampening circuitry in place, to prevent KESHA from being disabled (as children sometimes attempt to overcome parental safeguards).

Several different types of sound dampening circuits are possible and would also be effective. These include dynamic circuits which reduce the sound level by a variable amount over a continuum, for example only slightly dampening the electronic sound signal at lower levels but increasing the dampening effect as the amplitude of the electronic sound signal increases, or capping circuits, which do not alter lower levels of sound at all but which cap the maximum allowable sound output at a predetermined level. In the preferred embodiment, the sound dampening circuit is an attenuator comprised of a standard stereo input jack, a standard stereo output plug, three wires, and two resistors. The standard stereo input jack and the standard stereo output plug simply allow the KESHA to easily mesh and interact with both the headphones and the sound system equipment at issue, serving as a means for linking the electronic components in place between the headphones and the sound system equipment output jack (i.e. the outlet port on the sound system through which the electric sound signal is transmitted).

One wire acts as the positive wire, one acts as the negative wire, and one acts as the ground wire, connecting the standard stereo input jack to the standard stereo output plug. One resistor is placed in the path of the positive wire, and the other resistor is placed in the path of the negative wire. Typically, the two resistors range from 100 to 200 ohms, but in the preferred embodiment, both resistors are 150 ohms. This will result in a sound reduction of approximately 50%, so that whatever the input volume from the sound system is coming into the KESHA at the standard stereo input jack, the output volume will be approximately halved when it is transmitted to the headphones through the standard stereo output jack of KESHA. Thus, when the attenuator sound dampening circuit of the preferred embodiment is in place, the sound signal from the sound system equipment is uniformly reduced across the board, regardless of volume, before being transmitted on to the headphones. A person skilled in the art field will understand that these are merely illustrative examples of types of sound dampening circuits which may be used in KESHA, and are not intended to limit the scope of this invention in any way. Other sound dampening circuits will be known by person skilled in the art field as equivalents. These may serve as suitable substitutes which could also be used in KESHA, and are also intended to be included within the scope of this invention.

There are also several different ways in which the sound dampening circuit may be affixed in place. In order to be effective, KESHA must utilize an essentially permanent means for affixing or attaching the sound dampening circuit in place, so that the sound reduction capabilities cannot easily be disabled or disengaged. In the preferred embodiment, this is accomplished using a glue or epoxy material to permanently affix the KESHA sound dampening circuit element in place. Although a variety of adhesives are feasible, in the preferred embodiment, a superglue is utilized for its bonding strength capabilities, as this provides a secure hold. Another alternative means for affixing KESHA in place would utilize a push nut or push retainer, as a mechanical means for permanently locking KESHA in place. A person skilled in the art field will understand that these are merely illustrative examples and are not intended to limit the scope of this invention in any way; other equivalent means for securing the sound dampening circuit in place will be apparent to those skilled in the art field and may serve as suitable substitutes, and these are also intended to be included within the scope of this invention.

While the KESHA sound dampening circuit could be permanently affixed to the sound system equipment itself (so that it would be locked in place in the headphone port and any headphones used on the sound system equipment would be limited by the parental protection of KESHA, for example), typically KESHA is instead locked in place on the plug at the end of the cord for the headphones. Both techniques are effective. The first technique is perhaps more difficult for children to circumvent (since they cannot simply purchase new headphones without the protective KESHA unit, since the KESHA unit is actually part of the sound system). On the other hand, many people may be hesitant to permanently alter their stereo sound system equipment, given the cost of the equipment. Thus, it is usually preferable to affix the KESHA sound dampening circuit to the headphones, rather than to the stereo sound system equipment.

It is an object of the KESHA invention to provide parents with a tool for protecting their children from hearing damage associated with listening to music at excessive volumes using headphones. It is another object of this invention to reduce the chances of permanent hearing loss associated with using headphones with stereo sound system equipment. It is still another object of this invention to prevent children from circumventing parental safeguards related to hearing protection. It is yet another object of this invention to provide a sound dampening circuit to reduce the sound available in headphones, so there is less likelihood of permanent hearing loss from the use of headphones. It is yet another object of this invention to permanently affix the sound dampening circuit in place to prevent children from disengaging or disabling this parental safeguard. It is yet another object of this invention to ensure that the method for affixing the sound dampening circuit in place is simple to use, so that consumers may apply it themselves without the need for outside assistance. It is yet another object of this invention to provide a hearing protection device sufficiently simple, small, and convenient so that it will not substantially alter the manner in which headphones are used with sound system equipment. These and other objects will be readily apparent to those skilled in the art field.

### BRIEF DESCRIPTION OF DRAWINGS

Reference will be made to the drawings, where like parts are designated by like numerals and wherein:

FIG. 1 is an illustrative drawing of the preferred embodiment of KESHA, demonstrating its preferred location as an adapter plug attachment between the headphones and the stereo sound system equipment;

FIG. 2 is a schematic wire diagram of the preferred embodiment of KESHA; and

FIG. 3 is a circuit diagram of the attenuator (sound dampening circuit) element of the preferred embodiment of KESHA.

### DETAILED DESCRIPTION OF PREFERRED EMBODIMENT

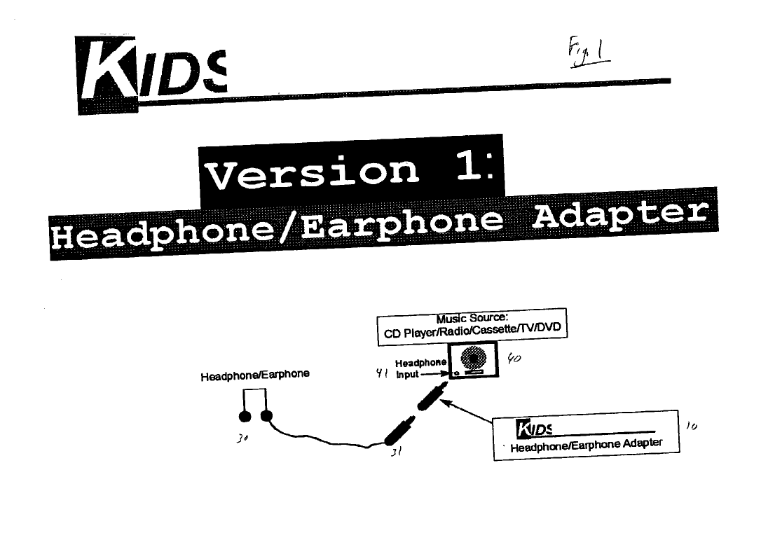

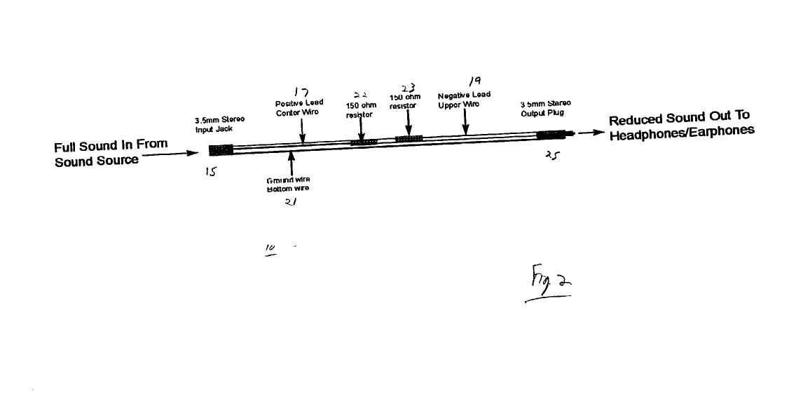

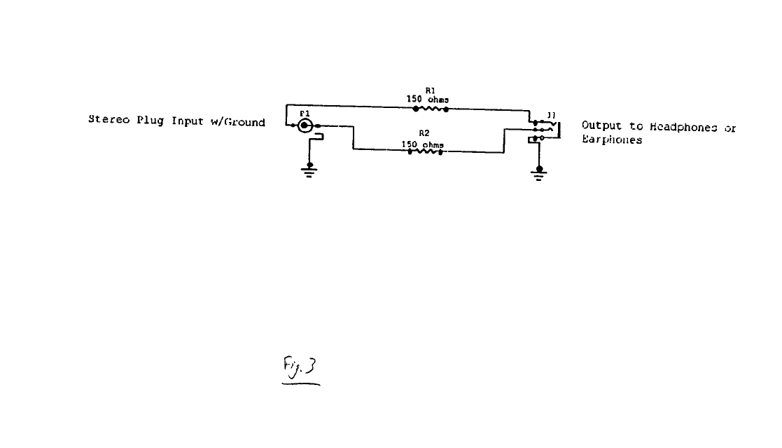

Referring now to the drawings in more detail, the preferred embodiment of KESHA is shown in FIGS. 1 and 2 and is generally designated by the numeral 10. The preferred embodiment of the attenuator (sound dampening circuit) element of KESHA 10 is shown in FIG. 3.

As FIG. 1 illustrates, KESHA 10 acts as an interface between a pair of headphones 30 and a stereo sound system 40, typically in the form of an adapter plug that fits onto the plug 31 of the headphones 30. In this way, KESHA 10 has the ability to alter the electronic sound signal from the sound system output jack 41 before it enters the headphones 30. The purpose of KESHA 10 is to provide parents with a tool for protecting their children's hearing from excessively high decibel levels in headphones 30. Thus, the primary elements of KESHA 10 are a means for dampening the input sound signal (typically a sound dampening circuit of some sort) and a means for affixing or locking the KESHA 10 in place, so that the hearing protection provided by the KESHA 10 device cannot be disengaged or disabled by children.

Several different types of sound dampening circuits are possible and would be effective. These include dynamic circuits which reduce the sound level by a variable amount over a continuum, for example only slightly dampening the electronic sound signal at lower levels but increasing the dampening effect as the amplitude of the electronic sound signal increases, or capping circuits, which do not alter lower levels of sound at all but which cap the maximum allowable sound output at a predetermined level (so that when the input sound signal from the sound system equipment 40 rises above the predetermined maximum level, the dampening circuit would hold the output sound signal to the headphones 30 at the predetermined maximum level). OSHA standards regarding safe volume levels could be used, for instance, to determine the appropriate levels at which to cap the maximum volume, based for example on the estimated amount of time that a typical teenager listens to music on headphones 30 continuously each day (see, for instance, Table G-16 under 29 CFR 1910.95, incorporated herein). Such a capping circuit would be designed to specifically ensure that decibel levels experienced in the headphones 30 over a period of time would not rise to a level likely to cause permanent hearing loss, and would ensure such sound levels regardless of the power of the sound system. A more complex capping circuit might also continuously adjust the maximum volume cap based upon recommended safety guidelines and the length of time that the headphones 30 have been used at various decibel levels over the course of the day (i.e. a floating maximum cap that would dynamically adjust downward over time rather than relying upon an assumption of average time spent listening to headphones 30).

The preferred embodiment of KESHA 10 uses a simpler sound dampening circuit, however, in order to reduce production costs. This type of simpler circuit does not necessarily guarantee safe decibel levels for all sound systems under all conditions (i.e. more powerful sound systems and longer exposure times may still produce hearing losses); rather, it simply reduces the sound level available in the headphones 30 linearly across the board, effectively reducing the maximum volume which may reach the headphones 30 so that there is less chance for hearing loss. In this way, this simpler type of circuit provides a safer level of sound in the headphones 30, which is less likely to cause permanent hearing damage than the original, undampened signal. It also should help to make users more aware of their decision to listen to an excessively loud volume, since they will have to compensate for the KESHA's reduction by increasing the volume on the sound system equipment 40 (resulting in high volume numbers on the sound system equipment 40, which should at least give them a moments pause).

In the preferred embodiment, the sound dampening circuit is an attenuator comprised of a standard stereo input jack 15, a standard stereo output plug 25, three wires, and two resistors, as shown in FIG. 2. The standard (3.5 mm) stereo input jack 15 and the standard (3.5 mm) stereo output plug 25 simply allow the KESHA 10 to easily mesh and interact with both the headphones 30 and the sound system equipment 40 at issue, serving as a means for linking the electronic components in place between the plug 31 of the headphones 30 and the sound system equipment output jack 41 (i.e. the outlet port on the sound system through which the electric sound signal is transmitted). The standard stereo input jack 15 serves to allow standardized headphones 30 to plug into the KESHA 10. The standard output plug 25 allows the KESHA 10 to plug into the output jack 41 in the sound system equipment 40, so that KESHA 10 receives the output signal from the sound system equipment 40.

Each wire in the attenuator may typically be up to 4 inches in length in the preferred embodiment. One wire acts as the positive wire 17, one acts as the negative wire 19, and one acts as the ground wire 21, connecting the standard stereo input jack 15 to the standard stereo output plug 25 and creating the attenuator circuit between the headphones 30 and the sound system equipment 40. One resistor 22 is located in the path of the positive wire 17 and soldered in place, and the other resistor 23 is located in the path of the negative wire 19 and soldered in place. The wires may be replaced with alternative conductors, so long as the circuit remains unchanged. Typically, the two resistors range from 100 to 200 ohms, but in the preferred embodiment, both resistors are 150 ohms. FIG. 3 shows the electrical circuit diagram of the attenuator of the preferred embodiment.

The attenuator reduces the sound signal from the sound system equipment 40 by a fixed amount, decreasing the input volume level from the sound system equipment 40 by an average of approximately 17.3 decibels in the preferred embodiment. Thus, whatever the sound level entering KESHA from the sound system equipment 40, the sound level received by the headphones 30 out of the preferred embodiment of KESHA 10 will be approximately 17.3 dbA lower. Obviously, there are several different ways in which the sound signal may be reduced, and a wide variety of sound dampening circuits are possible. A person skilled in the art field will understand that these are merely illustrative examples of types of sound dampening circuits which may be used in KESHA 10, and are not intended to limit the scope of this invention in any way. Other sound dampening circuits are known by persons skilled in the art field as equivalents. These may serve as suitable substitutes which could also be used in KESHA 10, and are also intended to be included within the scope of this invention.

There are also several different ways in which the sound dampening circuit may be affixed in place. In order to be effective, KESHA 10 must utilize an essentially permanent means for affixing, attaching, or locking the sound dampening circuit in place, so that the sound reduction capabilities cannot easily be disabled or disengaged. In the preferred embodiment, this is accomplished using an adhesive, such as a glue or epoxy, to permanently affix the sound dampening circuit element in place. Although a variety of adhesives are feasible, in the preferred embodiment, a standard superglue is utilized for its bonding strength properties, as this provides a secure hold. The adhesive would typically be provided to the end-user consumer in a tube, along with the sound dampening circuit, so that the end-user could apply the adhesive to the KESHA 10 and affix it permanently in place themselves. This would allow KESHA 10 to be marketed and sold at low cost and without the need for extensive servicing. Similarly, an adhesive circular tab (basically adhesive contact paper) could also be used, serving the same purpose as the superglue but perhaps providing a simpler application process for the end-user. In that case, the adhesive tab would already be affixed to the KESHA 10, and the end-user would simply remove the protective covering from the adhesive pad and hold the KESHA 10 in place, allowing the adhesive to affix the KESHA 10 into the proper location. An adhesive tape, of the type produced by 3M for example, could similarly be used.

For such adhesive techniques of affixing the sound dampening circuit in place, an adhesive with a tensile strength of approximately at least 4000 psi is generally recommended, in order to ensure a strong and effective bond that will securely hold the KESHA 10 in place. Another factor which might play a role in selecting a particular adhesive may be the adhesive's specific tensile strength characteristics with respect to the various materials it will be bonding together. In the preferred embodiment, the superglue adhesive would be applied to the male shaft of the plug 31 of the headphones 30, which would then be inserted into the standard stereo input jack 15 of the KESHA 10 (i.e. the female socket) and held in place until the adhesive had set, fixing the KESHA 10 in place permanently with respect to the headphones 30 in question. Persons skilled in the art field will be aware of a wide variety of equivalent adhesive products which may serve as suitable substitutes, all of which are included within the scope of this invention.

Another alternative means for affixing KESHA 10 in place would utilize a push nut or push retainer. This is a mechanical means for affixing the sound dampening circuit in place, and basically utilizes friction to lock the sound dampening circuit onto the plug 31 of the applicable headphones 30, for example. A push nut is a common fastener, widely available in commerce, and is typically a circular ring of spring steel with a hole in the middle, designed to hold attachments firmly in place on non-threaded shafts or rods. It does this utilizing beveled faces, angled so that a shaft may slide into the hole in the push nut without catching, but may not be removed from the hole in the push nut since the friction forces of the angled beveled faces will catch and bind the shaft in place in the hole of the push nut. Additional details about these types of push nuts are widely available to persons skilled in the art field; for example, McMASTER-CARR Style 2-Metric Push Retainers for Nonthreaded Shafts could be used for this application, and details about these push retainers are available at www.mcmaster.com, incorporated herein. The push nut is securely fastened into KESHA 10, for instance by gluing the push nut into place in the standard stereo input jack 15, with the beveled part of the push nut facing inward. This would allow the plug 31 of the headphones 30 to be inserted into the standard stereo input jack 15 of the KESHA 10, but it would not allow the plug 31 to removed, locking the KESHA 10 into place on the headphones 30. A person skilled in the art field will understand that these are merely illustrative examples of various means for affixing the KESHA 10 in place and are not intended to limit the scope of this invention in any way; other equivalent means for securing the sound dampening circuit in place will be apparent to those skilled in the art field and may serve as suitable substitutes, and these are also intended to be included within the scope of this invention.

While the sound dampening circuit could be permanently affixed to the sound system equipment 40 itself, so that it would be locked in place in the headphone jack 41 and any headphones 30 used on the sound system equipment 40 would be limited, for example, typically KESHA 10 is instead locked in place on the plug 31 at the end of the cord for the headphones 30. Both techniques are effective. The first technique is perhaps more difficult for children to circumvent (since they cannot simply purchase new headphones without the protective KESHA unit 10, since the KESHA unit 10 is actually part of the sound system 40). On the other hand, many people may be hesitant to permanently alter their stereo sound system equipment 40, given the cost of the equipment. Thus, it is usually preferable to affix the sound dampening circuit to the headphones 30, rather than to the stereo sound system equipment 40.

The preferred embodiment affixes the KESHA 10 permanently to the plug 31 of the headphone device 30, choosing to alter the less expensive headphone equipment 30 rather than the sound system equipment 40. This location also is less likely to result in damage to the sound system equipment 40, in the case of children attempting to violently override the parental safeguard provided by KESHA 10 (by pulling on KESHA 10 with extreme force, for example, and thereby damaging the electronic components to which KESHA 10 is rigidly affixed). Finally, this location typically provides an easier application process for affixing KESHA 10 in place, which is important since endusers will typically be performing the installation step themselves. Ultimately, however, location is simply a matter of choice. The only critical feature of location is that the sound dampening circuit must be able to act upon the electronic sound signal from the sound system equipment 40 before the signal reaches the headphones 30 (i.e. during transmission of the signal), in order to effectively reduce the sound level available in the headphones 30 to a safer level.

The KESHA 10 may also have a casing to house the sound dampening circuitry and to provide a firm foundation for the means for affixing KESHA 10 in place. Furthermore, the casing may provide both impact and electrical shock resistant capabilities, while providing a simple means for using KESHA 10 as an interface between a sound system 40 and headphones 30 (i.e. the standard stereo input jack 15 and standard stereo output plug 25 are typically incorporated into the casing). Finally, the casing may shield the electrical components of KESHA 10 from access, preventing children from tampering with the sound dampening circuitry in an attempt to override the protective device. In the preferred embodiment, KESHA 10 is incorporated within a unitary adapter plug of relatively small size, and the casing is simply modified from an existing standard headphone adapter housing for reasons of cost and convenience.

The specific embodiments and uses set forth herein are merely illustrative examples of the preferred embodiment of the KESHA 10 invention and are not intended to limit the present invention. A person skilled in the field will understand and appreciate additional embodiments and uses, which are also included within the scope of the present invention. The scope of the invention is more fully defined in the following claims, and the only limits to the scope of the invention are those set forth within the claims below.

What I claim is:

1. A kids ear saver headphone adapter device comprising:
a means for dampening an electronic sound signal; and
a means for affixing said means for dampening in place.

2. A kids ear saver headphone adapter as in claim 1 wherein said means for dampening is used to affect an electronic sound signal between a sound system and a pair of headphones, and wherein said means for affixing provides for an essentially permanent attachment of said means for dampening in place with respect to either said sound system or said headphones.

3. A kids ear saver headphone adapter as in claim 1 wherein said means for dampening further comprises an attenuator.

4. A kids ear saver headphone adapter as in claim 3 wherein said means for affixing further comprises an adhesive.

5. A kids ear saver headphone adapter as in claim 4 wherein said adhesive has a tensile strength of at least approximately 4000 psi.

6. A kids ear saver headphone adapter as in claim 5 wherein said attenuator is used to affect an electronic sound signal between a sound system and a pair of headphones, and wherein said adhesive is used to permanently affix said attenuator in place on the plug of said headphones.

7. A kids ear saver headphone adapter as in claim 3 wherein said attenuator further comprises an electric circuit with two resistors in parallel, wherein each of said resistors is between 100 and 200 ohms.

8. A kids ear saver headphone adapter as in claim 7 wherein both of said resistors are 150 ohms.

9. A kids ear saver headphone adapter as in claim 3 wherein said attenuator further comprises:
a stereo input jack;
a stereo output plug;
2 resistors; and
3 wires;
wherein one of said wires serves as the positive wire connecting said stereo input jack to said stereo output plug, one of said wires serves as the negative wire connecting said stereo input jack to said stereo output plug, and one of said wires serves as the ground wire connecting said stereo input jack to said stereo output plug, wherein one of said resistors is located in the path of said positive wire and one of said resistors is located in the path of said negative wire, and wherein each of said resistors is between 100 and 200 ohms.

10. A kids ear saver headphone adapter as in claim 9 wherein both of said resistors are 150 ohms.

11. A kids ear saver headphone adapter as in claim 5 wherein said attenuator further comprises an electric circuit with two resistors in parallel, wherein each of said resistors is between 100 and 200 ohms.

12. A kids ear saver headphone adapter as in claim 11 wherein both of said resistors are 150 ohms.

13. A kids ear saver headphone adapter as in claim 5 wherein said attenuator further comprises:
a stereo input jack;
a stereo output plug;
2 resistors; and
3 wires;
wherein one of said wires serves as the positive wire connecting said stereo input jack to said stereo output plug, one of said wires serves as the negative wire connecting said stereo input jack to said stereo output plug, and one of said wires serves as the ground wire connecting said stereo input jack to said stereo output plug, wherein one of said resistors is located in the path of said positive wire and one of said resistors is located in the path of said negative wire, and wherein each of said resistors is between 100 and 200 ohms.

14. A kids ear saver headphone adapter as in claim 13 wherein both of said resistors are 150 ohms.

15. A kids ear saver headphone adapter as in claim 3 wherein said means for affixing further comprises a push nut.

16. A kids ear saver headphone adapter as in claim 15 wherein said push nut is rigidly attached and located with respect to said attenuator so that the plug of a pair of headphones can be inserted into said push nut but cannot then be withdrawn.

17. A kids ear saver headphone adapter as in claim 16 wherein said attenuator further comprises an electric circuit with two resistors in parallel, wherein each of said resistors is between 100 and 200 ohms.

18. A kids ear saver headphone adapter as in claim 17 wherein both of said resistors are 150 ohms.

19. A kids ear saver headphone adapter as in claim 16 wherein said attenuator further comprises:
a stereo input jack;
a stereo output plug;
2 resistors; and
3 wires;
wherein one of said wires serves as the positive wire connecting said stereo input jack to said stereo output plug, one of said wires serves as the negative wire connecting said stereo input jack to said stereo output plug, and one of said wires serves as the ground wire connecting said stereo input jack to said stereo output plug, wherein one of said resistors is located in the path of said positive wire and one of said resistors is located in the path of said negative wire, and wherein each of said resistors is between 100 and 200 ohms.

20. A kids ear saver headphone adapter as in claim 19 wherein both of said resistors are 150 ohms.

21. A kids ear saver headphone adapter as in claim 1 wherein said means for dampening further comprises a capping sound dampening circuit.

22. A kids ear saver headphone adapter as in claim 21 wherein said means for affixing further comprises an adhesive.

23. A kids ear saver headphone adapter as in claim 22 wherein said adhesive has a tensile strength of at least approximately 4000 psi.

24. A kids ear saver headphone adapter as in claim 22 wherein said means for affixing further comprises a push nut.

25. A kids ear saver headphone adapter as in claim 1 wherein said means for dampening further comprises a dynamic sound dampening circuit.

26. A kids ear saver headphone adapter as in claim 25 wherein said means for affixing further comprises an adhesive.

27. A kids ear saver headphone adapter as in claim 26 wherein said adhesive has a tensile strength of at least approximately 4006 psi.

28. A kids ear saver headphone adapter as in claim 25 wherein said means for affixing further comprises a push nut.

29. A kids ear saver headphone adapter for protecting against hearing loss associated with the use of headphones for sound system equipment, comprising a sound dampening circuit and a means for affixing said sound dampening circuit in place.

30. A kids ear saver headphone adapter as in claim 29, wherein said sound dampening circuit is essentially permanently affixed in place with respect to either the applicable headphones or the applicable sound system equipment.

31. A kids ear saver headphone adapter as in claim 29 further comprising a casing which encloses said sound dampening circuit.

32. A kids ear saver headphone adapter as in claim 31 wherein said casing is physically shock resistant.

33. A kids ear saver headphone adapter as in claim 31 wherein said casing is electrically shock resistant.

34. A kids ear saver headphone adapter as in claim 31 wherein said means for affixing further comprises an adhesive.

35. A kids ear saver headphone adapter as in claim 34 wherein said adhesive has a tensile strength of at least approximately 4000 psi.

36. A kids ear saver headphone adapter as in claim 35 wherein said sound dampening circuit is an attenuator.

37. A kids ear saver headphone adapter as in claim 31 wherein said means for affixing further comprises a push nut.

38. A kids ear saver headphone adapter as in claim 37 wherein said push nut is rigidly attached to said casing and is located with respect to said sound dampening circuit so that the plug of the applicable headphones at issue can be inserted into said push nut but cannot then be withdrawn, essentially permanently affixing said sound dampening circuit in place on the plug of the applicable headphones.

39. A kids ear saver headphone adapter as in claim 38 wherein said sound dampening circuit is an attenuator.

40. A kids ear saver headphone adapter comprising:
a sound system;
a pair of headphones;
a sound dampening circuit; and
a means for affixing said sound dampening circuit in place;
wherein said sound system further comprises an output jack through which an electronic sound signal may be emitted, and said pair of headphones further comprises a plug; and
wherein said sound dampening circuit essentially permanently attaches to said plug of said headphones using said means for affixing, and said sound dampening circuit removably attaches to said output jack of said sound system equipment.

41. A kids ear saver headphone adapter as in claim 40 wherein said sound dampening circuit further comprises an attenuator.

42. A kids ear saver headphone adapter as in claim 41 wherein said means for affixing further comprises an adhesive.

43. A kids ear saver headphone adapter as in claim 41 wherein said means for affixing further comprises a push nut.

44. A kids ear saver headphone adapter as in claim 43 wherein said push nut is rigidly attached and located with respect to said sound dampening circuit so that the plug of the applicable headphones at issue can be inserted into said push nut but cannot then be withdrawn, affixing said dampening circuit in place on the plug of the applicable headphones.

45. A method for protecting the hearing of headphone users from excessive volumes generated by an electronic sound signal from sound system equipment with a sound dampening circuit, comprising the steps of:
locating said sound dampening circuit in place with respect to said headphones and said sound system equipment so that said sound dampening circuit is able to affect said electronic sound signal from said sound system equipment before it enters said headphones; and
essentially permanently affixing said sound dampening circuit in place with respect to either said headphones or said sound system equipment.

46. A method as in claim 45, wherein said sound dampening circuit further comprises an attenuator which reduces the volume level from said sound system equipment by a fixed amount before said electronic sound signal enters said headphones, and wherein said means for essentially permanently affixing said attenuator in place is an adhesive.
